(19) United States
(12) Patent Application Publication
(10) Pub. No.: US 2026/0011088 A1
(43) Pub. Date: Jan. 8, 2026

(54) VIDEO GENERATION METHOD AND APPARATUS, DEVICE, AND STORAGE MEDIUM

(71) Applicant: Tencent Technology (Shenzhen) Company Limited, Shenzhen (CN)

(72) Inventors: Jiaqi PAN, Shenzhen (CN); Yanglei WANG, Shenzhen (CN)

(21) Appl. No.: 19/327,985

(22) Filed: Sep. 12, 2025

Related U.S. Application Data
(63) Continuation of application No. PCT/CN2024/105534, filed on Jul. 15, 2024.

(30) Foreign Application Priority Data
Sep. 18, 2023 (CN) 202311212527.6

(51) Int. Cl. G06T 19/00

(52) U.S. Cl. CPC G06T 19/003

(57) ABSTRACT

A video generation method is performed by a computer device. The method includes: displaying a picture of a virtual scene, the picture including a virtual building in the virtual scene; in response to a framing operation for the virtual scene, shooting the virtual scene from n framing perspectives to obtain n framing images, the n framing images including a first framing image shot from a first framing perspective outside the virtual building and a second framing image shot from a second framing perspective inside the virtual building, and n being a positive integer; and in response to an operation configured for generating a video of touring the virtual building, generating a scene presentation video based on at least the first framing image and the second framing images in the n framing images. The method simplifies operations performed by a user and significantly improves generation efficiency of the scene presentation video.

### CROSS-REFERENCE TO RELATED APPLICATIONS

This application is a continuation application of PCT Patent Application No. PCT/CN2024/105534, entitled “VIDEO GENERATION METHOD AND APPARATUS, DEVICE, AND STORAGE MEDIUM” filed on Jul. 15, 2024, which claims priority to Chinese Patent Application No. 202311212527.6, entitled “VIDEO GENERATION METHOD AND APPARATUS, DEVICE, AND STORAGE MEDIUM” filed on Sep. 18, 2023, both of which are incorporated herein by reference in their entirety.

### FIELD OF THE TECHNOLOGY

Embodiments of this application relate to the field of computer and Internet technologies, and in particular, to a video generation method and apparatus, a device, and a storage medium.

### BACKGROUND OF THE DISCLOSURE

A massively multiplayer online game (MMO game for short) is a game type that allows a large quantity of game users to simultaneously interact with each other in a virtual world.

A massively multiplayer online game role-playing game (MMO RPG for short) is one type of the MMO game, and is a game that can enable a user to explore a game world through activities such as completing a task, battling, building a home, and interaction. In the related art, after completing decoration of a home, a user starts a screen recording function. The user moves a camera by controlling a joystick, and finally performs clipping by using video clipping software, to obtain a final presentation video.

### SUMMARY

Embodiments of this application provide a video generation method and apparatus, a device, and a storage medium. Technical solutions provided in the embodiments of this application are as follows:

According to an aspect of the embodiments of this application, a video generation method is performed by a computer device, and the method including:
displaying a picture of a virtual scene, the picture including a virtual building in the virtual scene;
in response to a framing operation for the virtual scene, shooting the virtual scene from n framing perspectives to obtain n framing images, the n framing images including a first framing image shot from a first framing perspective outside the virtual building and a second framing image shot from a second framing perspective inside the virtual building, and n being a positive integer; and
in response to an operation configured for generating a video of touring the virtual building, generating a scene presentation video based on at least the first framing image and the second framing images in the n framing images.

According to an aspect of the embodiments of this application, a computer device is provided, the computer device including a processor and a memory, the memory having a computer program stored therein, and the computer program being loaded and executed by the processor, to enable the computer device to implement the foregoing video generation method.

According to an aspect of the embodiments of this application, a non-transitory computer-readable storage medium is provided, the non-transitory computer-readable storage medium having a computer program stored therein, and the computer program, when being loaded and executed by a processor of a computer device, enabling the computer device to implement the foregoing video generation method.

The plurality of framing images are shot in the virtual scene, where the framing images are obtained by shooting the virtual scene from the different framing perspectives, so that the scene presentation video can be directly generated based on the framing images, thereby implementing automatic generation of the scene presentation video. A user can automatically generate the scene presentation video by using the device only by shooting the different framing images in the virtual scene, so that operations performed by the user are simplified, and production duration of the scene presentation video is significantly reduced. Therefore, generation efficiency of the scene presentation video is improved, so that the user can watch the scene presentation video as soon as possible, thereby improving interaction experience of the user, and further improving a human-computer interaction rate.

### BRIEF DESCRIPTION OF THE DRAWINGS

FIG. 1 is a schematic diagram of a solution implementation environment according to an embodiment of this application.

FIG. 2 is a flowchart of a video generation method according to an embodiment of this application.

FIG. 3 is a schematic diagram of a virtual scene according to an embodiment of this application.

FIG. 4 is a schematic diagram of a user interface according to an embodiment of this application.

FIG. 5 is a schematic diagram of a user interface according to another embodiment of this application.

FIG. 6 is a flowchart of a video generation method according to another embodiment of this application.

FIG. 7 is a schematic diagram of lens zoom-out according to an embodiment of this application.

FIG. 8 is a schematic diagram of lens zoom-in according to an embodiment of this application.

FIG. 9 is a schematic diagram of lens rotation according to an embodiment of this application.

FIG. 10 is a schematic diagram of lens close-up according to an embodiment of this application.

FIG. 11 is a schematic diagram of a camera moving mode of an outdoor framing point according to an embodiment of this application.

FIG. 12 is a schematic diagram of a camera moving mode of an indoor framing point according to an embodiment of this application.

FIG. 13 is a schematic diagram of scores of virtual items according to an embodiment of this application.

FIG. 14 is a schematic diagram of a framing point of a virtual item according to an embodiment of this application.

FIG. 15 is a schematic diagram of lens close-up according to another embodiment of this application.

FIG. 16 is a schematic diagram of a preview interface of a scene presentation video according to an embodiment of this application.

FIG. 17 is a program flowchart of a video generation method according to an embodiment of this application.

FIG. 18 is a block diagram of a video generation apparatus according to an embodiment of this application.

FIG. 19 is a block diagram of a video generation apparatus according to another embodiment of this application.

FIG. 20 is a block diagram of a structure of a terminal device according to an embodiment of this application.

FIG. 21 is a block diagram of a structure of a server according to an embodiment of this application.

### DESCRIPTION OF EMBODIMENTS

To make objectives, technical solutions, and advantages of this application clearer, the following further describes in detail implementations of this application with reference to the accompanying drawings.

In the related art, after completing decoration of a home, a user starts a screen recording function. The user moves a camera by controlling a joystick, and finally performs clipping by using video clipping software, to obtain a final home presentation video. However, when the home presentation video is recorded in this mode, problems of numerous operations and large time consumption exist. Consequently, generation efficiency of the home presentation video is low, the user needs to watch the home presentation video after long duration, interaction experience is poor, and a human-computer interaction rate is easily reduced. In some embodiments, the home may be a virtual building in a virtual scene, and the home presentation video may also be referred to as a scene presentation video.

FIG. 1 is a schematic diagram of a solution implementation environment according to an embodiment of this application. The solution implementation environment may include a terminal device 10 and a server 20.

The terminal device 10 includes, but is not limited to, an electronic device such as a mobile phone, a tablet computer, an intelligent voice interaction device, a game console, a wearable device, a multimedia playback device, a personal computer (PC), a vehicle-mounted terminal, an intelligent appliance, an augmented reality (AR) device, or a virtual reality (VR) device. A client of a target application program (such as a game application program) can be run in the terminal device 10. In some embodiments, the target application program may be an application program that needs to be downloaded and installed, or may be in a form of a web page or an applet. This is not limited in this embodiment of this application.

The applet is an application program that is developed based on a programming language and run depending on a host program. The applet does not need to be downloaded and installed, and only needs to be dynamically loaded in the host program to be run. A user may find a required applet in a manner such as searching or scanning, and may use the applet by tapping and opening the applet. After the applet is used and closed, an internal memory of the terminal device is not occupied, so that the applet is very convenient. The applet may be conveniently obtained and spread in the host program, and has excellent use experience. In some embodiments, the applet may also be referred to as an embedded program.

In this embodiment of this application, the target application program may be, but is not limited to, any one of a city building and management simulation game application program, an action-adventure game application program, a turn-based strategy game application program, a medieval building and strategy game application program, a war strategy game application program, a business strategy game application program, a simulation game (SLG for short) application program, a massively multiplayer online game (MMO game for short) application program, a massively multiplayer online role-playing game (MMO RPG for short) application program, a social application program, an interactive entertainment application program, a simulation program, a VR application program, an AR application program, a three-dimensional map application program, a virtual reality game application program, an augmented reality game application program, or the like.

In some embodiments, the target application program is the MMO game application program. The MMO game is a game type that allows a large quantity of game users to simultaneously interact with each other in a virtual world. The MMO game provides a virtual environment with energetic and good social interaction for the users, and the users explore a game world through completing tasks, battling, interaction, and other activities. In the MMO game, a user may build and manage a virtual home, city, or base in a home system, so that the user gains a sense of achievement.

In this embodiment of this application, the virtual scene is a scene displayed (or provided) when the client of the target application program (such as the game application program) is run on the terminal device. The virtual scene refers to an environment created for a virtual object to perform an activity (such as house construction or interior decoration). For example, the virtual scene may include a virtual building, and the virtual building may be a virtual house, a virtual living room, or a virtual bedroom. The virtual scene may be a simulation world of the real world, a semi-simulation and semi-fictitious three-dimensional world, or a purely fictitious three-dimensional world. The virtual scene may be any one of a two-dimensional virtual scene, a 2.5-dimensional virtual scene, and a three-dimensional virtual scene. In some embodiments, the virtual scene may also be referred to as a virtual environment.

The virtual building refers to a virtual element in a building form constructed by a user in the target application program. In this application, a display form of the virtual building is not limited. For example, the display form of the virtual building may include, but is not limited to, a form such as a house, a sports center, a farm, or a greenhouse. The virtual building may be presented in a three-dimensional form, or may be presented in a two-dimensional form. This is not limited in this embodiment of this application. In some embodiments, when the virtual scene is the three-dimensional virtual scene, the virtual building is a three-dimensional model. Each virtual building has a shape and a volume in the three-dimensional virtual scene, and occupies a part of space in the three-dimensional environment. In some embodiments, the virtual building may alternatively be implemented by using a 2.5-dimensional model or a two-dimensional model. This is not limited in this application.

The virtual object is an interactive element in the target application program. Using an example in which the target application program is the game application program, the virtual object is a virtual character controlled by a user or a server in the game application program. The virtual object may be in a form of a person, or may be an animal, a cartoon, or in another form. This is not limited in this embodiment of this application. The virtual object may be presented in a three-dimensional form, or may be presented in a two-dimensional form. This is not limited in this embodiment of this application. In some embodiments, when the virtual environment is a three-dimensional virtual environment, the virtual object is a three-dimensional model, for example, a three-dimensional model created based on a skeleton animation technology. Each virtual object has a shape and a volume in the three-dimensional virtual environment, and occupies a part of space in the three-dimensional virtual environment. An activity of the virtual object includes, but is not limited to, at least one of adjusting a body posture, crawling, walking, running, riding, flying, jumping, driving, picking up, shooting, attacking, throwing, or the like. For example, the virtual object is a virtual person, such as a simulation person character or an animation person character. In some implementations, the virtual object may alternatively be implemented by using a 2.5-dimensional model or a two-dimensional model. This is not limited in this embodiment of this application. The virtual object may be controlled by a server, or may be controlled by a user by using a client. This is not limited in this application.

The server 20 is configured to provide a background service for the client of the target application program in the terminal device 10. For example, the server 20 may be an independent physical server, a server cluster or distributed system including a plurality of physical servers, or a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform, but is not limited thereto.

The terminal device 10 and the server 20 may communicate with each other by using a network. The network may be a wired network or a wireless network.

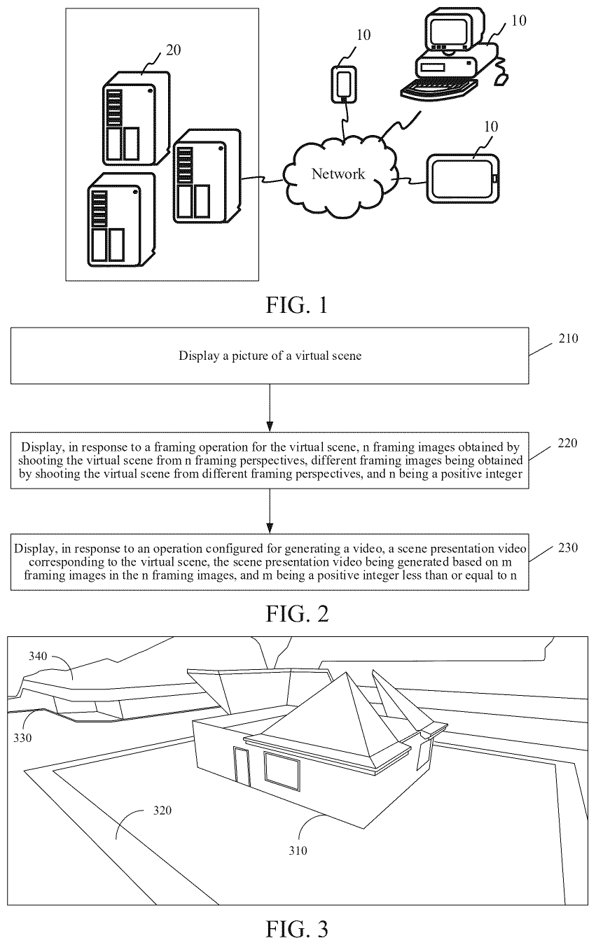

FIG. 2 is a flowchart of a video generation method according to an embodiment of this application. An execution body of operations of this method may be a computer device. For example, the computer device may be the terminal device 10 in the solution implementation environment shown in FIG. 1, and the execution body of the operations may be the client of the target application program run in the terminal device 10. In the following embodiments, for ease of description, introduction and descriptions are provided based on that the execution body of the operations is the “client”. The method may include at least one of the following operations (210 to 230).

Operation 210: Display a picture of a virtual scene.

In some embodiments, the virtual scene may be constructed or decorated by a user, or may be an initialized scene in the target application program.

In some embodiments, the target application program provides different types of virtual elements for the user. The virtual element may include, but is not limited to, a virtual house, a virtual swimming pool, a virtual farm, a virtual plant, virtual furniture, a virtual ornament, or the like. The user implements decoration or another activity on the virtual scene by disposing the virtual element. The type of the virtual element is not limited in this application.

For example, FIG. 3 is a schematic diagram of a virtual scene according to an embodiment of this application. The virtual scene includes a virtual house 310, virtual floor tiles 320, a virtual wall 330, and a virtual rockery 340. The virtual wall 330 and the virtual rockery 340 are preset scenes, that is, initialized scenes of the target application program. A user disposes the virtual house 310 at a central position of a picture of the virtual scene, and disposes a circle of virtual floor tiles 320 around the virtual house 310, to form a road.

In some embodiments, the virtual element in the virtual scene may be observed and adjusted by using a zoom control.

In some embodiments, a user interface displayed by the client may include a picture layer and a control layer. A display layer of the control layer is above the picture layer. The picture layer is configured for displaying the picture of the virtual scene. The control layer is configured for displaying a user interface (UI for short) control, such as the zoom control described above and another control mentioned below.

In the foregoing manner, the user disposes different virtual elements in the virtual scene to beautify the picture of the virtual scene, and displays the picture of the virtual scene to prepare for a subsequent framing operation of the user.

Operation 220: Display, in response to a framing operation for the virtual scene, n framing images obtained by shooting the virtual scene from n framing perspectives, different framing images being obtained by shooting the virtual scene from different framing perspectives, and n being a positive integer.

The framing operation for the virtual scene is an operation performed by the user and configured for shooting the framing images. For example, the user performs the framing operation for the virtual scene for n times, to obtain the n framing images through shooting. One framing image can be shot in each framing operation. Certainly, one framing image can be shot in one framing operation, or a plurality of framing images can be shot in one framing operation. For example, one framing operation may be an operation of tapping a shooting control for a single time. In this case, one framing image may be shot. For another example, one framing operation may be an operation of long pressing and tapping the shooting control. In this case, the plurality of framing images may be shot.

In some embodiments, the user may perform shooting by tapping a control configured for responding to the framing operation for the virtual scene, or may perform shooting by using a gesture.

For example, the shooting control exists on the user interface. After the shooting control is tapped, shooting of a current framing perspective may be completed once, to obtain a framing image corresponding to the current framing perspective.

For example, the user completes shooting of the current framing perspective once by knocking a screen of the terminal device twice by using a finger pulp, to obtain the framing image corresponding to the current framing perspective.

In some embodiments, the picture of the virtual scene is at the picture layer of the user interface. The control layer of the user interface may include a switch control, the zoom control, and the shooting control, and the control layer is above the picture layer.

In some embodiments, the switch control is configured for controlling a displayed state and a hidden state of all controls of the user interface. When all the controls are in the hidden state, the picture of the virtual scene is not blocked by another control. When all the controls are in the displayed state, the framing operation for the virtual scene may be performed.

In some embodiments, the zoom control is configured for adjusting a zoom level of a virtual element in the virtual scene. The zoom level is a measurement standard of a degree of zooming in or zooming out of the virtual element in the virtual scene, and is configured for indicating a size ratio of the virtual element. The virtual element includes, but is not limited to, the following elements: a virtual house, a virtual tree, a virtual fence, and the like.

In some embodiments, the user may control, by using the different framing perspectives, a virtual object to perform an activity in the virtual scene. Under the different framing perspectives, virtual scenes observed by the user are different. The different framing perspectives may include, but are not limited to, the following framing perspectives: a first-person perspective, a third-person perspective, a high-angle perspective, a low-angle perspective, a bird's eye perspective, a side view perspective, and the like. For example, when the user performs an activity in the virtual scene in the first-person perspective, the picture of the virtual scene is a picture viewed from a perspective of the virtual object, that is, the user is disposed in the current virtual scene. When the current virtual scene is in the third-person perspective, the picture of the virtual scene includes the virtual object, and the user may observe a picture in which the virtual object performs an activity in the virtual scene, that is, the user is out of the current virtual scene.

In some embodiments, an image obtained by observing the virtual scene from an adjusted framing perspective is displayed in response to an operation of adjusting the framing perspective. The user may flexibly adjust content of the picture of the virtual scene by adjusting the framing perspective, so that a visual effect is good, and the user can be prompted to more quickly shoot the framing image, thereby improving generation efficiency of a scene presentation video.

When the user performs the framing operation, the framing perspective is a position and an angle at which the user performs framing in the virtual scene.

In some embodiments, the user may continuously adjust the current framing perspective by controlling a virtual joystick, to determine a position of the framing perspective. Alternatively, the current framing perspective may be adjusted by controlling a virtual arrow key, to determine the position of the framing perspective. The virtual joystick may be a visible control, or may be an invisible control. This is not limited in this application. For example, the virtual joystick is a disk-shaped visual control. A movement direction of the picture of the virtual scene can be controlled by dragging the virtual joystick, and the movement direction of the picture is consistent with a dragging direction of the virtual joystick. For example, the virtual joystick is an invisible control. A movement direction of the picture of the virtual scene can be controlled through dragging in a specified range on the user interface. A start point of the dragging is a position of the virtual joystick, and the movement direction of the picture is consistent with a dragging direction.

In some embodiments, the user performs dragging at a position without a control in the virtual scene, to adjust an angle of the framing perspective. For example, when dragging is performed upward at the position without a control in the virtual scene, the angle of the current framing perspective is accordingly changed upward. Other directions are the same.

For example, the framing perspective is configured for determining how to shoot the virtual scene. The framing perspective includes a framing position and a framing angle. For example, the framing position may be a position of the virtual object controlled by the user in the virtual scene when the virtual scene is shot, and the framing angle may be an orientation of the virtual object controlled by the user when the virtual scene is shot.

For example, the framing image is obtained by shooting the virtual scene from the framing perspective by using a virtual camera. The framing perspective is configured for determining how the virtual camera shoots the virtual scene. For example, the framing position in the framing perspective is configured for determining a shooting position of the virtual camera when the virtual camera shoots the virtual scene, and the framing angle in the framing perspective is configured for determining a shooting angle of the virtual camera when the virtual camera shoots the virtual scene.

In some embodiments, the user may adjust a zoom level of the picture of the current virtual scene by controlling the zoom control, or may adjust the zoom level of the current virtual scene by using a gesture, to change a size and a field of view of the virtual scene. For example, the user adjusts the zoom level of the picture of the current virtual scene by controlling the zoom control. The zoom control is a slider control, and a slide is dragged to perform zooming. For example, the user adjusts the zoom level of the picture of the current virtual scene by using a gesture. The virtual scene is zoomed in through pinch-in on the screen, and the virtual scene is zoomed out by unfolding a finger on the screen.

There are a plurality of manners of adjusting the current framing perspective and the size of the picture. The manner in this embodiment or another manner may be used during actual application. This is not limited in this application.

In some embodiments, the n framing images obtained by shooting the virtual scene from the n framing perspectives are displayed in an image presentation bar, the image presentation bar being displayed at an upper layer of the picture of the virtual scene.

The image presentation bar is a visual tool configured for presenting the shot framing images. In some embodiments, the image presentation bar is on the user interface, the image presentation bar includes n framing image boxes, and one framing image box is configured for presenting one framing image. For example, a sequential position of the framing image may be adjusted by tapping and dragging the framing image box, or positions of two different framing image boxes may be replaced by tapping the two different framing image boxes. For example, the framing image presented in the framing image box may further be deleted by dragging the framing image box to a position of a trash control or tapping a deletion control in the framing image box.

According to the foregoing method, the user previews, in the image presentation bar, the picture that is currently framed. This helps the user quickly determine, by viewing the image presentation bar, the picture that needs to be framed next, thereby improving efficiency of obtaining the framing image, and improving the generation efficiency of the scene presentation video. Therefore, the user can watch the scene presentation video as soon as possible, thereby improving interaction experience of the user, and further improving a human-computer interaction rate.

In some embodiments, a video generation control is further displayed in the image presentation bar.

In some embodiments, the video generation control may alternatively be located at any position at the control layer.

The displaying, in response to an operation configured for generating a video, a scene presentation video corresponding to the virtual scene includes: displaying, in response to an operation for the video generation control, the scene presentation video corresponding to the virtual scene. In some embodiments, the operation for the video generation control may be a tapping operation on the video generation control, for example, a single-tapping operation or a double-tapping operation.

Convenience of the operation for the video generation control is high. Generation and display of the video are triggered by the operation generated for the video generation control, to help improve efficiency of generating and displaying the video, so that the user can watch the scene presentation video as soon as possible, thereby improving the interaction experience of the user, and further improving the human-computer interaction rate.

In some embodiments, the user performs, by tapping the video generation control, the operation configured for generating the video, or may perform, by using a gesture, the operation configured for generating the video. For example, the user may knock the screen of the terminal device for three times by using a knuckle, to complete the operation configured for generating the video. A specific manner in which the operation configured for generating the video is implemented is set by a person skilled in the art, and is not limited in this application.

In some embodiments, the image presentation bar has a corresponding display or hiding control, and the display or hiding control is configured for switching a status of the image presentation bar between a displayed state and a hidden state. The method provided in this embodiment of this application further includes: switching the status of the image presentation bar from the hidden state to the displayed state in response to an operation for the display or hiding control when the image presentation bar is in the hidden state, that is, displaying the image presentation bar; or switching the status of the image presentation bar from the displayed state to the hidden state in response to an operation for the display or hiding control when the image presentation bar is in the displayed state, that is, canceling displaying the image presentation bar.

The operation for the display or hiding control may be a tapping operation on the display or hiding control, for example, a single-tapping operation or a double-tapping operation. The display or hiding control is a control that has different functions in different cases. When the image presentation bar is in the hidden state, the display or hiding control is a control having a display function. If the operation for the display or hiding control is obtained, the status of the image presentation bar is switched from the hidden state to the displayed state, to display the image presentation bar. When the image presentation bar is in the displayed state, the display or hiding control is a control having a hiding function. If the operation for the display or hiding control is obtained, the status of the image presentation bar is switched from the displayed state to the hidden state, to hide the image presentation bar, that is, cancel displaying the image presentation bar. The display or hiding control may be displayed at any position on the user interface. This is not limited in this embodiment of this application.

In some embodiments, a quantity of shot framing images is displayed on the display or hiding control. In this way, even though the image presentation bar is in the hidden state, the user can still know the quantity of currently shot framing images.

According to the foregoing method, the control of the image presentation bar is hidden by switching the status of the image presentation bar from the displayed state to the hidden state, to provide the complete picture of the virtual scene for the user, and help the user better complete the framing operation. The status of the image presentation bar is switched from the hidden state to the displayed state, to provide the framing image for preview, and help the user determine a next framing image. The user can flexibly operate the display or hiding control based on a requirement, so that operation flexibility of a process in which the framing image is shot is improved, thereby improving the interaction experience of the user and improving the human-computer interaction rate.

The displayed state of the image presentation bar means that the image presentation bar is currently in a visible state. The image presentation bar is displayed in a particular region of the user interface. In this case, the user may interact with a control in the image presentation bar.

The hidden state of the image presentation bar means that the image presentation bar is currently in an invisible state. The image presentation bar is invisible and does not occupy space on the user interface. In this case, the user cannot interact with the control in the image presentation bar.

In some embodiments, when the status of the image presentation bar is switched from the displayed state to the hidden state, another control that is on the same interface as the image presentation bar also enters the hidden state. Similarly, when the status of the image presentation bar is switched from the hidden state to the displayed state, another control that is on the same interface as the image presentation bar also enters the displayed state. The another control is a control such as the zoom control mentioned above. When statuses of all controls on the same interface are switched to the hidden state, more comprehensive details of the picture of the virtual scene can be provided for the user.

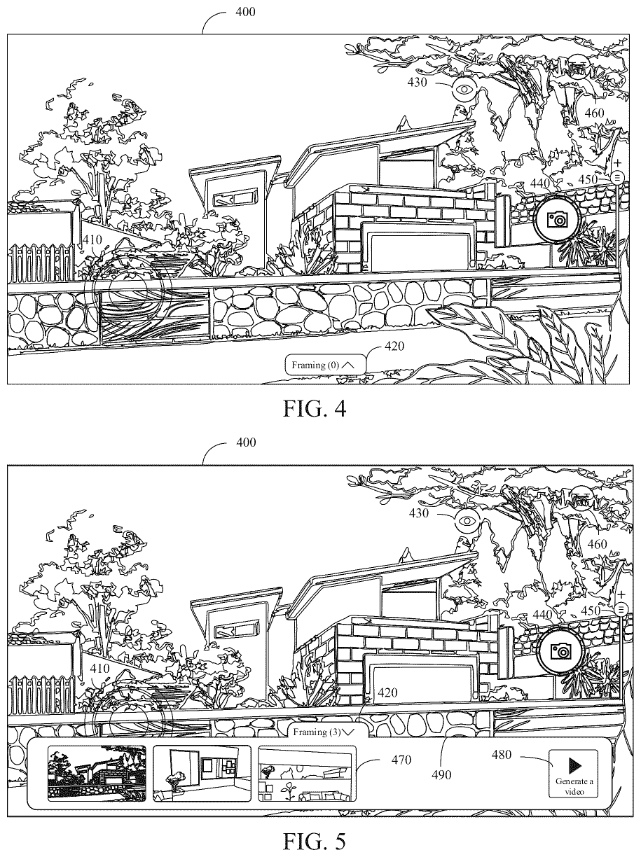

In some embodiments, a shooting control is further displayed at the upper layer of the picture of the virtual scene, and the framing operation is an operation for the shooting control. For example, as shown in FIG. 4, a shooting control 440 is tapped, so that a framing image can be shot from a current framing perspective. Convenience of the operation for the shooting control is high. The framing operation is triggered by the operation generated for the shooting control, to help improve efficiency of shooting the framing image, and further improve the efficiency of generating and displaying the scene presentation video, so that the user can watch the scene presentation video as soon as possible, thereby improving the interaction experience of the user, and further improving the human-computer interaction rate.

In some embodiments, one framing image box is added after a last framing image box in the image presentation bar after shooting of a p^{th} time is performed, to present a framing image corresponding to a framing operation of the p^{th} time, where p is less than or equal to n, and p is a positive integer.

For example, FIG. 4 is a schematic diagram of a user interface according to an embodiment of this application. The user interface 400 is located in a picture of a virtual scene, and includes a visible virtual joystick 410, a display or hiding control 420, a switch control 430, a shooting control 440, a zoom control 450, and a virtual unmanned aerial vehicle control 460. FIG. 5 is a schematic diagram of a user interface according to another embodiment of this application. The user interface 400 includes a visible virtual joystick 410, a display or hiding control 420, a switch control 430, a shooting control 440, a zoom control 450, and a virtual unmanned aerial vehicle control 460 that are in one-to-one correspondence with the controls in FIG. 4. After the display or hiding control 420 is tapped, in FIG. 5, in comparison with FIG. 4, a framing image box 470, a video generation control 480, and an image presentation bar 490 are added. To be specific, after the display or hiding control 420 is tapped, a status of the image presentation bar 490 is switched from a hidden state to a displayed state, and statuses of the framing image box 470, the video generation control 480, and the image presentation bar 490 are also switched from an invisible state to a visible state.

According to the foregoing method, the user determines at least one framing perspective by adjusting a perspective of the current virtual scene, and shoots at least one framing image, to provide a material for subsequent generation of the scene presentation video.

In some embodiments, after operation 220, the following operation is further included: marking and displaying, in response to an operation of selecting a framing image, the framing image selected from the n framing images, m framing images including the selected framing image. The selected framing image is marked and displayed, so that the user can intuitively distinguish the selected framing image from an unselected framing image, thereby improving visual experience of the user, and further improving the human-computer interaction rate.

The user selects the m framing images from the image presentation bar. There are many manners of marking and displaying the selected framing image, which include, but are not limited to, at least one of the following manners: marking in highlight, marking by using a transparent region, marking by using an icon, marking by using a symbol, marking by using a text prompt, marking by using a color mark, and the like. In some embodiments, the manner of marking and displaying the selected framing image may include at least one of the following: highlighting the selected framing image, setting a background of the selected framing image to be transparent, displaying a selected icon on the selected framing image, displaying a selected symbol on the selected framing image, displaying a selected text on the selected framing image, or setting a framing image box in which the selected framing image is located to be in a target color. The selected icon is any icon that can prompt that the framing image is selected, the selected symbol is any symbol that can prompt that the framing image is selected, the selected text is any text that can prompt that the framing image is selected, and the target color is different from a color of a framing image box in which an unselected framing image is located.

If the user does not perform the operation of selecting the framing image, the n framing images are all configured for generating the scene presentation video. That is, in this case, m is equal to n.

In some embodiments, when the selected framing image is marked and displayed, a selection order of the framing image is marked and displayed.

In the foregoing manner, the framing image that is finally configured for generating the scene presentation video is selected, to help subsequent generate the corresponding scene presentation video by using the framing image.

Operation 230: Display, in response to an operation configured for generating a video, a scene presentation video corresponding to the virtual scene, the scene presentation video being generated based on m framing images in the n framing images, and m being a positive integer less than or equal to n.

In some embodiments, m is equal to n. In this case, the scene presentation video is generated based on all the n framing images. The scene presentation video is generated in consideration of all the shot framing images, to help improve reliability of the scene presentation video.

In some embodiments, m is less than n. In this case, the scene presentation video is generated based on a part of the n framing images. The scene presentation video is generated in consideration of a part of the shot framing images, to help improve generation efficiency of the scene presentation video.

In some embodiments, when m is less than n, the m framing images may be images that are selected by the user from the n framing images, or may be images that are selected by the client from the n framing images.

For example, the client selects the m framing images from the n framing images. The client may randomly select the m framing images from the n framing images, or the client may select the m framing images from the n framing images according to a selection rule. The selection rule may be set based on experience, or may be flexibly adjusted based on an application scenario. This is not limited in this embodiment of this application. For example, the selection rule may be selecting m framing images with latest shooting time points.

In some embodiments, the scene presentation video may be generated based on a sequence in which the m framing images are selected. Alternatively, the scene presentation video may be generated based on a shooting sequence of the m selected framing images. Alternatively, the m framing images may be classified based on different framing points, and then the scene presentation video is generated based on classified framing images.

According to the foregoing method, the corresponding scene presentation video is previewed, to help the user adjust the framing images, so that the scene presentation video that is more satisfied for the user is obtained.

In conclusion, in the technical solution provided in this embodiment of this application, the plurality of framing images are shot in the virtual scene, where the framing images are obtained by shooting the virtual scene from the different framing perspectives, so that the scene presentation video can be directly generated based on the framing images, thereby implementing automatic generation of the scene presentation video. A user can automatically generate the scene presentation video by using the device only by shooting the different framing images in the virtual scene, so that operations performed by the user are simplified, and production duration of the scene presentation video is significantly reduced. Therefore, the generation efficiency of the scene presentation video is improved, so that the user can watch the scene presentation video as soon as possible, thereby improving the interaction experience of the user, and further improving the human-computer interaction rate.

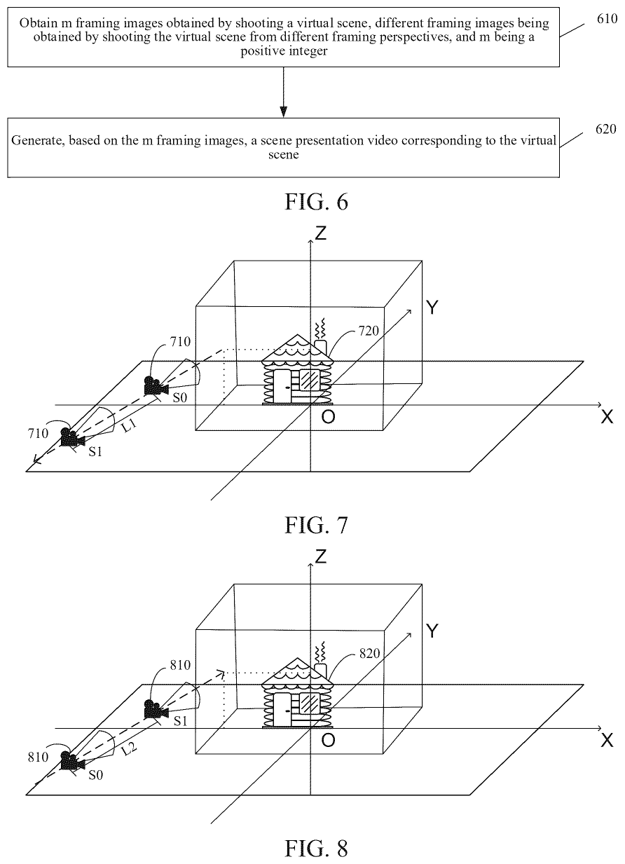

FIG. 6 is a flowchart of a video generation method according to another embodiment of this application. An execution body of operations of this method may be a computer device. For example, the computer device may be the terminal device 10 in the solution implementation environment shown in FIG. 1, or may be the server 20 in the solution implementation environment shown in FIG. 1. For example, the execution body of the operations may be the client or server of the target application program run in the terminal device 10. In the following embodiments, for ease of description, introduction and descriptions are provided based on that the execution body of the operations is the “server”. The method may include at least one of the following operations (610 and 620).

Operation 610: Obtain m framing images obtained by shooting a virtual scene, different framing images being obtained by shooting a virtual scene from different framing perspectives, and m being a positive integer.

The m framing images are obtained from the client. After responding to an operation configured for generating a video, the client sends the m framing images to the server. For example, the m framing images may be framing images selected by a user from n shot framing images, or may be framing images selected by the client from n shot framing images, or may be n framing images shot by the user. This is not limited in this embodiment of this application.

In the foregoing manner, the m framing images are obtained from the client, to provide materials for subsequent generation of a scene presentation video.

Operation 620: Generate, based on the m framing images, a scene presentation video corresponding to the virtual scene.

In some embodiments, camera moving modes respectively corresponding to the m framing images are determined, the camera moving mode being configured for indicating a moving path and a shooting angle of a virtual camera; scene presentation clips respectively corresponding to the m framing images are generated based on the camera moving modes respectively corresponding to the m framing images, a scene presentation clip corresponding to an i^{th} framing image in the m framing images being a video clip obtained by controlling the virtual camera to shoot the virtual scene based on a moving path and a shooting angle of the virtual camera that are indicated by a camera moving mode corresponding to the i^{th} framing image, and i being a positive integer less than or equal to m; and the scene presentation video is generated based on the scene presentation clips respectively corresponding to the m framing images.

The camera moving mode refers to moving the virtual camera to change a distance and fluctuation in the picture of the virtual scene, so that the shot picture in the video can present more details. The virtual camera herein and the virtual camera that shoots the framing image may be the same virtual camera, or may be different virtual cameras. This is not limited in this embodiment of this application.

There are a plurality of camera moving modes, which may include, but are not limited to, the following modes: lens zoom-out, lens zoom-in, lens rotation, lens following, and the like. All the camera moving modes can indicate a moving path and a shooting angle of the virtual camera. The shooting angle is configured for indicating a lens orientation of the virtual camera during movement along the moving path.

The lens zoom-out means moving the virtual camera away from a shot body by a distance, and a moving path of the virtual camera is on a straight line passing a current position of the virtual camera and extending along a current shooting angle of the virtual camera. The shot body is a main body or a focus in a framing image, and is a composition core of the framing image. For the camera moving mode of the lens zoom-out, during movement of the virtual camera along the moving path indicated by the lens zoom-out, the shooting angle of the virtual camera remains unchanged. In other words, during the movement of the virtual camera along the moving path indicated by the lens zoom-out, the lens orientation of the virtual camera remains unchanged. For example, a lens of the virtual camera always faces the shot body.

For example, FIG. 7 is a schematic diagram of lens zoom-out according to an embodiment of this application. A position of a virtual camera 710 before lens zoom-out is S0. After the virtual camera moves away from a shot body 720 by a distance L1 along a straight line on which S0 and a current angle of the virtual camera are located, a shooting angle of the virtual camera 710 remains unchanged, and the position of the virtual camera 710 changes to S1. In other words, the movement of the virtual camera 710 from S0 to S1 is a process of the lens zoom-out.

The lens zoom-in means moving the virtual camera to the shot body by a distance, and a moving path of the virtual camera is on the straight line passing the current position of the virtual camera and extending along the current shooting angle of the virtual camera. For the camera moving mode of the lens zoom-in, during movement of the virtual camera along the moving path indicated by the lens zoom-in, the shooting angle of the virtual camera remains unchanged. In other words, during the movement of the virtual camera along the moving path indicated by the lens zoom-in, the lens orientation of the virtual camera remains unchanged. For example, the lens of the virtual camera always faces the shot body.

For example, FIG. 8 is a schematic diagram of lens zoom-in according to an embodiment of this application. A position of a virtual camera 810 before lens zoom-in is S0. After the virtual camera moves to a shot body 820 by a distance L2 along a straight line on which S0 and a current angle of the virtual camera are located, a shooting angle of the virtual camera 810 remains unchanged, and the position of the virtual camera 810 changes to S1. In other words, the movement of the virtual camera 810 from S0 to S1 is a process of the lens zoom-in.

The lens rotation means rotating the virtual camera by an angle by using the shot body as a center, and a moving path of the virtual camera is a curve obtained by horizontally rotating a connection line between the current position of the virtual camera and a center of the shot body clockwise or anticlockwise by the angle. For example, for the camera moving mode of the lens rotation, during movement of the virtual camera along the moving path indicated by the lens rotation, the shooting angle of the virtual camera may remain unchanged. In other words, during the movement of the virtual camera along the moving path indicated by the lens rotation, the lens orientation of the virtual camera remains unchanged. For example, for the camera moving mode of the lens rotation, during the movement of the virtual camera along the moving path indicated by the lens rotation, the shooting angle of the virtual camera may alternatively be continuously adjusted with the movement, so that the lens of the virtual camera always faces the shot body.

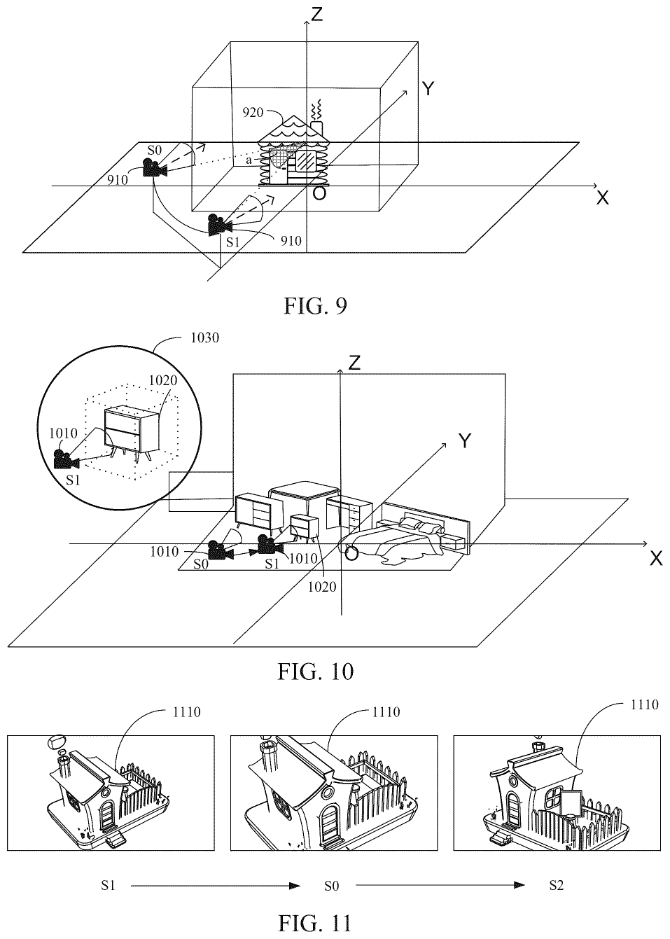

For example, FIG. 9 is a schematic diagram of lens rotation according to an embodiment of this application. A position of a virtual camera 910 before lens rotation is S0. After the virtual camera 910 is horizontally rotated anticlockwise around a Z-axis by an angle a, a distance between the virtual camera 910 and a shot body 920 remains unchanged, a shooting angle of the virtual camera 910 remains unchanged, and the position changes to S1. In other words, the movement of the virtual camera 910 from S0 to S1 is a process of the lens rotation.

Lens close-up means that the virtual camera moves to the shot body and a shooting angle of the virtual camera is adjusted to an optimal shooting angle, and a moving path of the virtual camera is a path along which the virtual camera moves to an optimal shooting point of the shot body. For the camera moving mode of the lens close-up, during the movement of the virtual camera along the moving path indicated by the lens close-up, the shooting angle of the virtual camera is gradually adjusted to the optimal shooting angle of the shot body. The optimal shooting point and the optimal shooting angle of the shot body may be set based on experience, or may be flexibly adjusted as required. This is not limited in this embodiment of this application.

For example, FIG. 10 is a schematic diagram of lens close-up according to an embodiment of this application. A position of a virtual camera 1010 before lens close-up is S0, and an optimal shooting point of a shot body 1020 is S1. As shown in an enlarged view 1030, the virtual camera 1010 moves along a connection line between S0 and S1. During the movement, a shooting angle of the virtual camera 1010 is gradually adjusted to an optimal shooting angle, and the position of the virtual camera 1010 changes to S1. In other words, the movement of the virtual camera 1010 from S0 to S1 is a process of the lens close-up.

In some embodiments, for different framing images, there may be different combinations of camera moving modes.

According to the foregoing method, a scene presentation clip corresponding to each framing image may be generated for each framing image by determining a proper camera moving mode for each framing image, to help smoothly present details in the corresponding framing image by using the scene presentation clip, thereby improving an effect of the finally generated scene presentation video, so that visual experience of watching the scene presentation video by the user is improved, and the human-computer interaction rate is improved.

For example, the process of controlling the virtual camera to shoot the virtual scene based on the moving path and the shooting angle of the virtual camera that are indicated by the camera moving mode corresponding to the i^{th} framing image, to obtain the scene presentation clip corresponding to the i^{th} framing image may be: controlling the virtual camera to move along the moving path indicated by the camera moving mode corresponding to the i^{th} framing image, and controlling, during the movement, the lens orientation of the virtual camera based on the shooting angle indicated by the camera moving mode corresponding to the i^{th} framing image; and using a video clip shot by the virtual camera during the movement as the scene presentation clip corresponding to the i^{th} framing image.

In some embodiments, a framing-point type corresponding to the i^{th} framing image is determined for the i^{th} framing image based on a framing-point position of the i^{th} framing image, the framing-point type being an outdoor framing point or an indoor framing point; and it is determined, if the framing-point type of the i^{th} framing image is the outdoor framing point, that the camera moving mode corresponding to the i^{th} framing image is a first camera moving mode; or it is determined, if the framing-point type of the i^{th} framing image is the indoor framing point, that the camera moving mode corresponding to the i^{th} framing image is a second camera moving mode; the first camera moving mode being different from the second camera moving mode.

The framing-point position is a shooting position and a shooting angle of the virtual camera when the virtual camera shoots a corresponding framing image, and one framing image corresponds to one framing-point position. Because factors such as a size of a shot body and a presented detail of the indoor framing point and the outdoor framing point are different, a shooting mode for the indoor framing point and a shooting mode for the outdoor framing point are different.

In the foregoing manner, different camera moving modes are determined based on different framing-point types, so that a generated scene presentation clip includes more details that need to be presented in a framing image. This helps improve a matching degree between the generated scene presentation clip and a framing-point type of the framing image, to further improve the effect of the scene presentation video generated based on the scene presentation clip, so that the visual experience of watching the scene presentation video by the user is improved, and the human-computer interaction rate is improved.

In some embodiments, the first camera moving mode includes: the lens zoom-in and the lens rotation. That scene presentation clips respectively corresponding to the m framing images are generated based on the camera moving modes respectively corresponding to the m framing images includes: controlling the virtual camera to perform lens zoom-in, to move the virtual camera from a first position to a second position along a first direction when the camera moving mode corresponding to the i^{th} framing image is the first camera moving mode, the second position being the framing-point position of the i^{th} framing image, a distance between the first position and the second position being a first distance, and the first direction being a lens orientation when the i^{th} framing image is shot; controlling the virtual camera to perform lens rotation, to rotate the virtual camera from the second position to a third position in a horizontal plane around a first straight line by a first angle, the first straight line being perpendicular to the horizontal plane; and controlling the virtual camera to shoot the virtual scene based on a determined shooting angle during the movement of the virtual camera, to obtain the scene presentation clip corresponding to the i^{th} framing image.

The first camera moving mode is configured for shooting at the outdoor framing point. When shooting is performed outdoor, the shot body is an object with a large volume, such as a virtual building. The lens close-up is applicable to shooting details of a small item. Therefore, the lens close-up is not used herein. Because details of the shot body need to be shot, neither the lens zoom-out is applicable. When the camera moving mode of the lens zoom-in is used, details of a currently oriented surface of the shot body can be obtained, and details of other surfaces of the shot body can be obtained through the lens rotation. For example, the virtual building may include a virtual house, a virtual swimming pool, and a virtual farm.

In some embodiments, a manner of obtaining the scene presentation clip corresponding to the i^{th} framing image includes: controlling the virtual camera to shoot the virtual scene based on a first moving path and a first shooting angle when the camera moving mode corresponding to the i^{th} framing image is the first camera moving mode, to obtain the scene presentation clip corresponding to the i^{th} framing image. The first camera moving mode includes the lens zoom-in and the lens rotation. The first moving path includes a first sub-path that is indicated by the lens zoom-in and that is of moving from a first position to a second position along a first direction, and a second sub-path that is indicated by the lens rotation and that is of rotating from the second position to a third position in a horizontal plane around a first straight line by a first angle. The second position is the framing-point position of the i^{th} framing image. A distance between the first position and the second position is a first distance. The first direction is a lens orientation when the i^{th} framing image is shot. The first straight line is perpendicular to the horizontal plane. The first shooting angle includes a first shooting sub-angle that is indicated by the lens zoom-in and that is of the virtual camera during movement along the first sub-path, and a second shooting sub-angle that is indicated by the lens rotation and that is of the virtual camera during movement along the second sub-path.

For example, the first shooting sub-angle and the second shooting sub-angle are both configured for enabling the lens of the virtual camera to always face the first direction. To be specific, the shooting angle of the virtual camera always remains unchanged either during the movement along the first sub-path or during the movement along the second sub-path.

For example, the first shooting sub-angle is configured for enabling the lens of the virtual camera to always face the first direction during the movement along the first sub-path. In other words, the shooting angle of the virtual camera always remains unchanged during the movement along the first sub-path. The second shooting sub-angle is configured for enabling the lens of the virtual camera to always face a shot body in the i^{th} framing image during the movement along the second sub-path. Because the second sub-path is a path for rotating the virtual camera, and a position of the shot body remains unchanged, the shooting angle of the virtual camera is gradually adjusted during the movement along the second sub-path.

For example, a process of controlling the virtual camera to shoot the virtual scene based on the first moving path and the first shooting angle, to obtain the scene presentation clip corresponding to the i^{th} framing image may include: controlling the virtual camera to move along the first sub-path, and controlling the lens orientation of the virtual camera based on the first shooting sub-angle during the movement; controlling the virtual camera to move along the second sub-path after the virtual camera moves to the second position, and controlling the lens orientation of the virtual camera based on the second shooting sub-angle during the movement; and splicing a video clip shot during the movement of the virtual camera along the first sub-path and a video clip shot during the movement of the virtual camera along the second sub-path, to obtain the scene presentation clip corresponding to the i^{th} framing image.

For example, FIG. 11 is a schematic diagram of a camera moving mode of an outdoor framing point according to an embodiment of this application. A framing-point position of a framing image corresponds to a position S0 (corresponding to a second position) in a preview image. A current framing point is an outdoor framing point. A shot body in a virtual scene is a virtual house 1110. Camera moving shooting is performed in a first camera moving mode, to be specific, shooting is performed by using a combination of lens zoom-in and lens rotation. A virtual camera moves back to a position S1 (corresponding to a first position) along a direction of a shooting angle of the framing point by a first distance. The virtual camera moves from S1 to S0 to implement camera movement of the lens zoom-in. Then, the virtual camera is rotated anticlockwise from S0 to a position S2 (corresponding to a third position) around a center point of the virtual house 1110 by a first angle, to implement camera movement of the lens rotation.

In the foregoing manner, the first camera moving mode is determined as the camera moving mode for the outdoor framing point based on characteristics of the outdoor framing point: a large volume of the shot body and many details that need to be shot, to help shoot a proper scene presentation clip with smooth camera movement. The scene presentation clip corresponding to the framing image shot at the outdoor framing point is generated based on the camera moving modes of the lens zoom-in and the lens rotation, so that the scene presentation clip can include both the details of the currently oriented surface of the shot body and the details of the other surfaces of the shot body. Therefore, the scene presentation clip can present details of many surfaces of the shot body, to improve a presentation effect of the scene presentation clip.

In some embodiments, the second camera moving mode includes: the lens zoom-in and the lens close-up. That scene presentation clips respectively corresponding to the m framing images are generated based on the camera moving modes respectively corresponding to the m framing images includes: controlling the virtual camera to perform lens zoom-in, to move the virtual camera from a fourth position to a second position along a first direction when the camera moving mode corresponding to the i^{th} framing image is the second camera moving mode, the second position being the framing-point position of the i^{th} framing image, a distance between the fourth position and the second position being a second distance, and the first direction being a lens orientation when the i^{th} framing image is shot; controlling the virtual camera to perform lens close-up, to move the virtual camera from the second position to a fifth position, and controlling to adjust the lens orientation of the virtual camera from the first direction to a second direction during the movement, the fifth position being a set framing-point position corresponding to a first virtual item included in the i^{th} framing image, and the second direction being a set lens orientation corresponding to the first virtual item; and controlling the virtual camera to shoot the virtual scene based on a determined shooting angle during the movement of the virtual camera, to obtain the scene presentation clip corresponding to the i^{th} framing image.

The second camera moving mode is configured for shooting at the indoor framing point. When shooting is performed indoor, the shot body is an object with a small volume, such as virtual furniture or a virtual ornament. Therefore, it is suitable to use the lens close-up to perform shooting. In addition to the shot body, an indoor panorama further needs to be shot. If the lens zoom-out is used for shooting, shooting is not smooth with the lens close-up. Therefore, a combination of the lens zoom-in and the lens close-up is used as the second camera moving mode.

In some embodiments, a manner of obtaining the scene presentation clip corresponding to the i^{th} framing image includes: controlling the virtual camera to shoot the virtual scene based on a second moving path and a second shooting angle when the camera moving mode corresponding to the i^{th} framing image is the second camera moving mode, to obtain the scene presentation clip corresponding to the i^{th} framing image. The second camera moving mode includes the lens zoom-in and the lens close-up. The second moving path includes a third sub-path that is indicated by the lens zoom-in and that is of moving from a fourth position to a second position along a first direction, and a fourth sub-path that is indicated by the lens close-up and that is of moving from the second position to a fifth position. The second position is the framing-point position of the i^{th} framing image. A distance between the fourth position and the second position is a second distance. The first direction is a lens orientation when the i^{th} framing image is shot. The fifth position is a set framing-point position corresponding to a first virtual item included in the i^{th} framing image. The second shooting angle including a third shooting sub-angle that is indicated by the lens zoom-in and that is of the virtual camera during movement along the third sub-path, and a fourth shooting sub-angle that is indicated by the lens close-up and that is of the virtual camera during movement along the fourth sub-path. The fourth shooting sub-angle is configured for controlling to adjust the lens orientation of the virtual camera from the first direction to a second direction, and the second direction is a set lens orientation corresponding to the first virtual item.

For example, the third shooting sub-angle is configured for enabling the lens of the virtual camera to always face the first direction during the movement along the third sub-path. To be specific, the shooting angle of the virtual camera always remains unchanged during the movement along the third sub-path.

For example, a process of controlling the virtual camera to shoot the virtual scene based on the second moving path and the second shooting angle, to obtain the scene presentation clip corresponding to the i^{th} framing image may include: controlling the virtual camera to move along the third sub-path, and controlling the lens orientation of the virtual camera based on the third shooting sub-angle during the movement; controlling the virtual camera to move along the fourth sub-path after the virtual camera moves to the second position, and controlling the lens orientation of the virtual camera based on the fourth shooting sub-angle during the movement; and splicing a video clip shot during the movement of the virtual camera along the third sub-path and a video clip shot during the movement of the virtual camera along the fourth sub-path, to obtain the scene presentation clip corresponding to the i^{th} framing image.

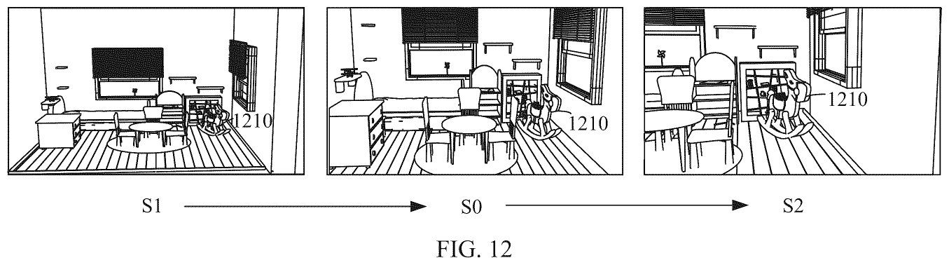

For example, FIG. 12 is a schematic diagram of a camera moving mode of an indoor framing point according to an embodiment of this application. A framing-point position of a framing image corresponds to a position S0 (corresponding to a second position) in a preview image. A current framing point is an indoor framing point. A shot body in a virtual scene is a virtual wood horse 1210, which is a first virtual item that requires close-up. Camera moving shooting is performed in a second camera moving mode, to be specific, shooting is performed by using a combination of lens zoom-in and lens close-up. A virtual camera moves back to a position S1 (corresponding to a fourth position) along a direction of a shooting angle of the framing point by a second distance. The virtual camera moves from S1 to S0 to implement camera movement of the lens zoom-in. The virtual camera moves from S0 to S2 (corresponding to a fifth position). During the movement, a lens orientation of the virtual camera is gradually adjusted to a second direction, to implement camera movement of the lens close-up for the virtual wood horse 1210.

In the foregoing manner, the second camera moving mode is determined as the camera moving mode for the indoor framing point based on characteristics of the indoor framing point: a small volume of the shot body and a requirement for close-up, to help shoot a proper scene presentation clip with smooth camera movement. The scene presentation clip corresponding to the framing image shot at the indoor framing point is generated based on the camera moving modes of the lens zoom-in and the lens close-up, so that close-up is performed on the shot body with a small volume in the scene presentation clip, and shooting smoothness is ensured, thereby improving a presentation effect of the scene presentation clip.

In some embodiments, a value score respectively corresponding to at least one virtual item included in the i^{th} framing image is determined, the value score being configured for representing a shooting value of the virtual item; and a virtual item with a highest value score is determined as the first virtual item.

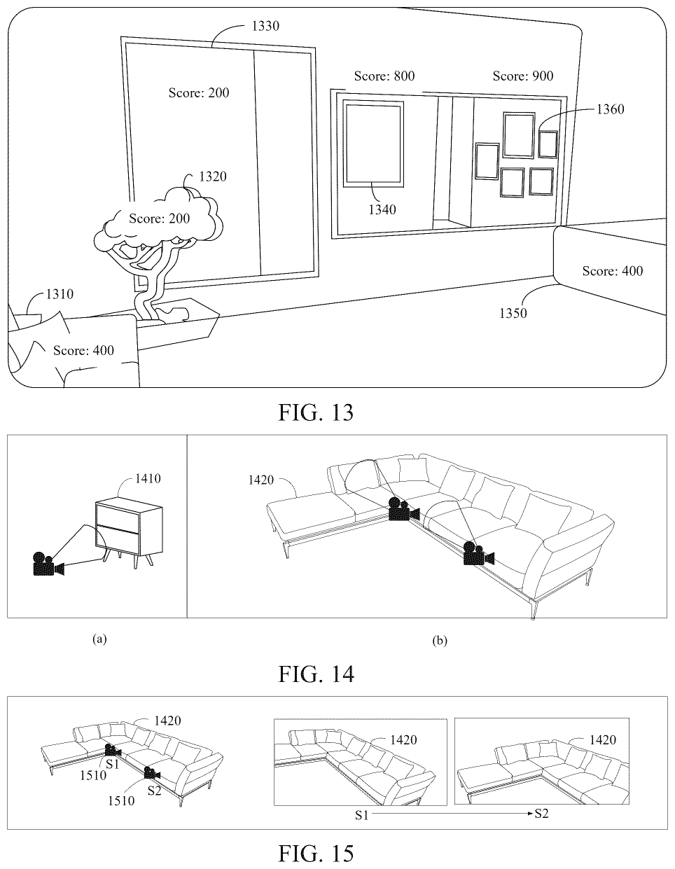

In some embodiments, a virtual item in a framing image may be comprehensively scored based on factors such as aesthetic and rarity of the virtual item. A virtual item with a higher value score indicates that the virtual item has a higher shooting value and a higher shooting priority. For example, FIG. 13 is a schematic diagram of scores of virtual items according to an embodiment of this application. A current virtual scene includes six virtual items: a value sofa 1310 (score: 400), a virtual bonsai 1320 (score: 200), a virtual window 1330 (score: 200), a virtual picture frame 1340 (score: 800), a virtual bed 1350 (score: 400), and a virtual photo frame 1360 (score: 900). Assuming that close-up is performed on at most two virtual items in each framing image, two virtual items with highest value scores are selected for close-up, that is, the two virtual items are determined as first virtual items. Therefore, the virtual picture frame 1340 and the virtual photo frame 1360 are determined as the first virtual items.

In some embodiments, when the first virtual item includes a plurality of virtual items, a close-up sequence is generated based on distances between the virtual items and the framing-point position. The close-up sequence is a sequence of performing lens close-up on the virtual items. When lens close-up is performed on the plurality of virtual items based on the close-up sequence, the fifth position is a set framing-point position corresponding to a virtual item ranked last in the close-up sequence, the fourth sub-path includes sub-paths respectively corresponding to the plurality of virtual items, and a sub-path corresponding to a virtual item ranked first in the close-up sequence is moving from the second position to a set framing-point position corresponding to the virtual item ranked first in the close-up sequence. A sub-path corresponding to a virtual item ranked kth in the close-up sequence is moving from a set framing-point position corresponding to a virtual item ranked (k−1)^{th} in the close-up sequence to a set framing-point position corresponding to the virtual item ranked kth in the close-up sequence, where k is an integer greater than 1 and not greater than n, and n is a quantity of the plurality of virtual items.

In the foregoing manner, when a framing image includes a plurality of virtual items, shooting values of the virtual items can be obtained through value scores, and a virtual item with a high value score is selected for close-up. This helps generate a scene presentation clip with high user satisfaction, thereby improving the human-computer interaction rate.

In some embodiments, when the first virtual item corresponds to a plurality of set framing-point positions, a set shooting sequence of the plurality of set framing-point positions is obtained; and the virtual camera is controlled to perform lens close-up, sequentially starting the second position to the plurality of set framing-point positions based on the set shooting sequence. In other words, the fourth sub-path is a path sequentially starting from the second position to the plurality of set framing-point positions based on the set shooting sequence of the plurality of set framing-point positions corresponding to the first virtual item.

The lens close-up is applicable to shooting details of a small item, but there is also a virtual item with a large volume. A full view or details of the virtual item cannot be shot by using a single time of lens close-up. Therefore, a plurality of framing positions need to be set for shooting.

For example, FIG. 14 is a schematic diagram of a framing point of a virtual item according to an embodiment of this application. A first virtual item 1410 in a sub-figure (a) in FIG. 14 is a virtual item with a small volume. Therefore, only one framing point is required to complete lens close-up. A virtual item 1420 in a sub-figure (b) in FIG. 14 is a virtual item with a large volume. Therefore, two framing points are required to complete lens close-up.

For example, FIG. 15 is a schematic diagram of lens close-up according to another embodiment of this application. FIG. 15 shows a process of completing lens close-up in the sub-figure (b) of FIG. 14. Framing points corresponding to the virtual item 1420 are S1 and S2. A virtual camera 1510 first moves from a current position to the framing point S1. During the movement, a shooting angle of the virtual camera is also gradually adjusted to a shooting angle corresponding to the framing point S1. Then, the virtual camera moves from the framing point S1 to the framing point S2, and the shooting angle of the virtual camera is also gradually adjusted to a shooting angle corresponding to the framing point S2.

In the foregoing manner, the plurality of framing points are set for the virtual item with a large volume in the framing image, to perform shooting of the lens close-up, so that completeness of shooting details of the virtual item in a scene presentation clip generated by using the framing image can be ensured, thereby improving satisfaction of the user with the scene presentation clip, and improving the human-computer interaction rate.

In some embodiments, that a framing-point type corresponding to the i^{th} framing image is determined based on a framing-point position of the i^{th} framing image includes: obtaining a construction region of a virtual building corresponding to the i^{th} framing image; and determining, if the framing-point position of the i^{th} framing image is located outside the construction region, that the framing-point type corresponding to the i^{th} framing image is the outdoor framing point; or determining, if the framing-point position of the i^{th} framing image is located within the construction region, that the framing-point type corresponding to the i^{th} framing image is the indoor framing point. Whether the framing-point type is the outdoor framing point or the indoor framing point is determined based on whether the framing-point position is located outside or within the construction region, to help improve accuracy of determining the framing-point type, thereby improving generation reliability of the scene presentation clip corresponding to the framing image.

There are many manners of determining the framing-point type, which include, but are not limited to, one of the following manners: a method of environment rendering and mapping, a collision detection method, a method of special effects of a skybox and an environment, a design element method, a method of map data and region marking, and the like. For example, when the method of map data and region marking is used, relative distances between the framing-point position and a center point of the virtual building in a horizontal direction, a vertical direction, and a depth direction may be respectively calculated based on coordinates of the construction region of the virtual building and coordinates of the framing-point position. If the horizontal relative distance is less than a half of a width of the virtual building, the vertical relative distance is less than a half of a length of the virtual building, and the depth relative distance is less than a half of a height of the virtual building, it may be determined that the framing point is the indoor framing point. In another case, the framing point is the outdoor framing point.

The virtual camera has a height limitation in a process of framing and video shooting. The height limitation is configured for ensuring that the virtual camera performs framing and shooting in a normal framing region. The normal framing region may be a region other than an abnormal framing region, and the abnormal framing region may be below the ground. The height limitation is set by a person skilled in the art, and is not limited in this application.

In some embodiments, the scene presentation clips respectively corresponding to the m framing images are spliced, to generate the scene presentation video. The scene presentation video is obtained by splicing the plurality of scene presentation clips, so that smoothness of the scene presentation video is high, thereby improving the satisfaction of the user with the scene presentation video, and further improving the human-computer interaction rate.

In some embodiments, splicing is performed based on a sequence of framing time points of the m framing images, to generate the scene presentation video.

For example, the m scene presentation clips corresponding to the m framing images are spliced based on the sequence of the framing time points of the m framing images, to generate the complete scene presentation video.

In some embodiments, the m framing images are spliced based on a first sequence, to generate the scene presentation video, the first sequence being determined by the user.

For example, before responding to the operation configured for generating the video, the user sorts the m framing images in the image presentation bar, to determine a splicing sequence of the m scene presentation clips, that is, determine the first sequence, and splices the m scene presentation clips based on the first sequence, to generate the complete scene presentation video.

In some embodiments, the m framing images are spliced based on framing-point types, to generate the scene presentation video.

For example, the scene presentation clips corresponding to the m framing images are first classified into outdoor scene presentation clips and indoor scene presentation clips based on types of framing points, and then the m scene presentation clips are spliced based on distances of the framing points, to generate the complete scene presentation video.

In some embodiments, after the scene presentation video is generated, a video preview interface is displayed at an upper layer of the picture of the current virtual scene, the video preview interface being configured for presenting the scene presentation video. For example, FIG. 16 is a schematic diagram of a preview interface of a scene presentation video according to an embodiment of this application. A video preview interface 1600 includes a scene presentation video frame 1610, a regeneration control 1620, a video progress bar control 1630, a download control 1640, a publishing control 1650, and a control 1660 for closing the video preview interface. The scene presentation video frame 1610 is configured for playing a scene presentation video. The scene presentation video frame 1610 includes the video progress bar control 1630. The video progress bar control 1630 is configured for viewing a video play progress. The regeneration control 1620 is configured for returning to a framing operation. The download control 1640 is configured for locally downloading the scene presentation video. The publishing control 1650 is configured for publishing the scene presentation video to a social platform. The control 1660 for closing the video preview interface is configured for closing the video preview interface 1600.

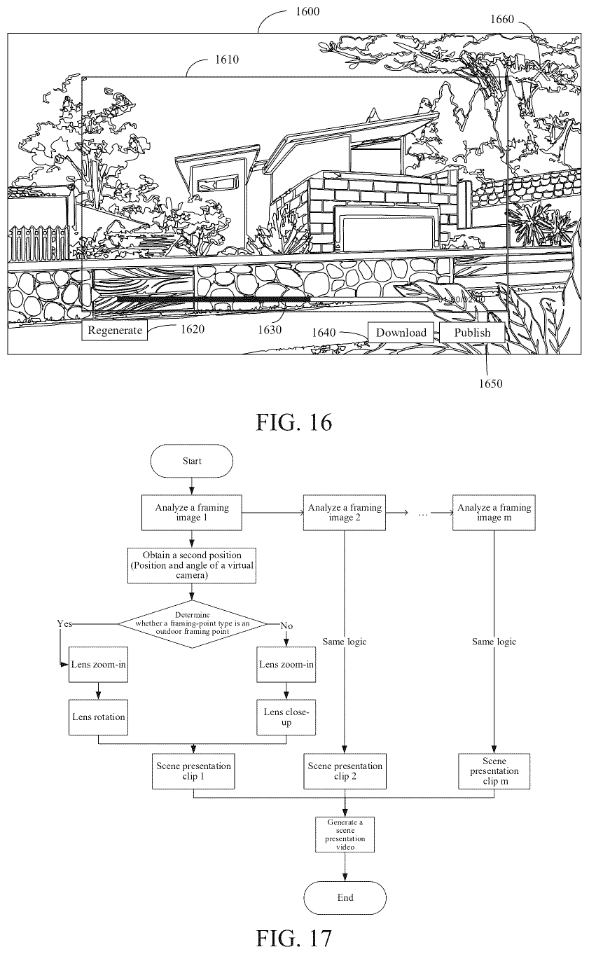

For example, FIG. 17 is a program flowchart of a video generation method according to an embodiment of this application. After m framing images selected by a user are obtained, each of the framing images is analyzed, a type of a framing point is determined based on a second position corresponding to the framing image, that is, a position and an angle at which a virtual camera shoots the framing image, and a camera moving mode corresponding to the framing point is determined based on the type of the framing point. If the framing point is an outdoor framing point, the corresponding camera moving mode is lens zoom-in and lens rotation. If the framing point is an indoor framing point, the camera moving mode is lens zoom-in and lens close-up. After recording is performed based on the foregoing camera moving mode, a scene presentation clip corresponding to the framing image is obtained. Each of the framing images is processed based on the same logic. After all the framing images are processed, m scene presentation clips are obtained, and the m scene presentation clips are spliced to obtain a complete scene presentation video.

In conclusion, in the technical solution provided in this embodiment of this application, the plurality of framing images shot in the virtual scene are obtained, so that the scene presentation video can be directly generated based on content of the framing images, thereby implementing automatic generation of the scene presentation video, simplifying operations performed by the user, and significantly reducing production duration of the scene presentation video. Therefore, the generation efficiency of the scene presentation video is improved, so that the user can watch the scene presentation video as soon as possible, thereby improving the interaction experience of the user, and further improving the human-computer interaction rate.

Apparatus embodiments of this application are described below, and may be used to perform the method embodiments of this application. For details not disclosed in the apparatus embodiments of this application, refer to the method embodiments of this application.

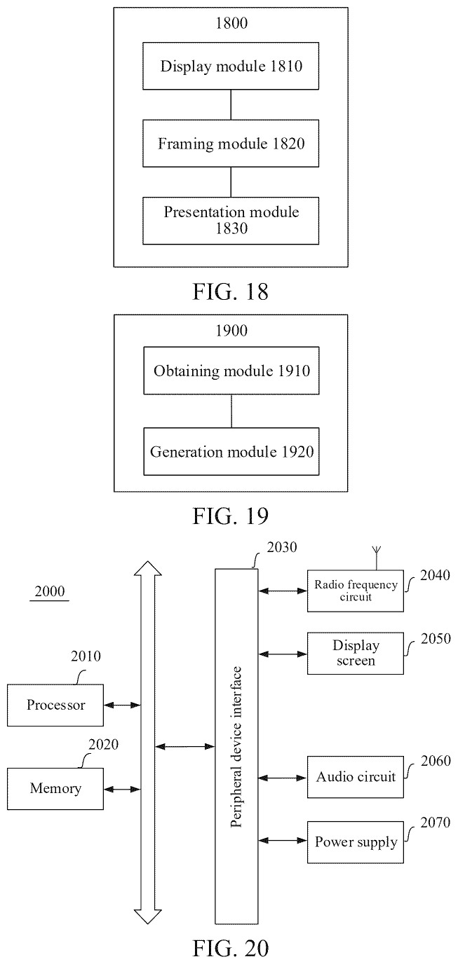

FIG. 18 is a block diagram of a video generation apparatus according to an embodiment of this application. The apparatus has a function of performing the foregoing method embodiments. The function may be implemented by hardware or may be implemented by hardware executing corresponding software. The apparatus may be the terminal device introduced above, or may be disposed in the terminal device. As shown in FIG. 18, the apparatus 1800 may include a display module 1810, a framing module 1820, and a presentation module 1830.

The display module 1810 is configured to display a picture of a virtual scene.

The framing module 1820 is configured to display, in response to a framing operation for the virtual scene, n framing images obtained by shooting the virtual scene from n framing perspectives, different framing images being obtained by shooting the virtual scene from different framing perspectives, and n being a positive integer.

The presentation module 1830 is configured to display, in response to an operation configured for generating a video, a scene presentation video corresponding to the virtual scene, the scene presentation video being generated based on m framing images in the n framing images, and m being a positive integer less than or equal to n.

In some embodiments, the framing module 1820 is configured to display, in an image presentation bar, the n framing images obtained by shooting the virtual scene from the n framing perspectives, the image presentation bar being displayed at the upper layer of the picture of the virtual scene.

In some embodiments, a video generation control is further displayed in the image presentation bar. The presentation module 1830 is configured to display, in response to an operation for the video generation control, the scene presentation video corresponding to the virtual scene.

In some embodiments, the image presentation bar has a corresponding display or hiding control, and the display or hiding control is configured for switching a status of the image presentation bar between a displayed state and a hidden state. The framing module 1820 is further configured to switch the status of the image presentation bar from the hidden state to the displayed state in response to an operation for the display or hiding control when the image presentation bar is in the hidden state; or switch the status of the image presentation bar from the displayed state to the hidden state in response to an operation for the display or hiding control when the image presentation bar is in the displayed state.

In some embodiments, a shooting control is further displayed at the upper layer of the picture of the virtual scene, and the framing operation is an operation for the shooting control.

In some embodiments, the display module 1810 is further configured to display, in response to an operation of adjusting the framing perspective, an image obtained by observing the virtual scene from an adjusted framing perspective.

In some embodiments, the apparatus 1800 further includes a marking module (which is not shown in FIG. 18).

The marking module is configured to mark and display, in response to an operation of selecting a framing image, the framing image selected from the n framing images, the m framing images including the selected framing image.

In conclusion, in the technical solution provided in this embodiment of this application, the plurality of framing images are shot in the virtual scene, where the framing images are obtained by shooting the virtual scene from the different framing perspectives, so that the scene presentation video can be directly generated based on the framing images, thereby implementing automatic generation of the scene presentation video. A user can automatically generate the scene presentation video by using the device only by shooting the different framing images in the virtual scene, so that operations performed by the user are simplified, and production duration of the scene presentation video is significantly reduced. Therefore, the generation efficiency of the scene presentation video is improved, so that the user can watch the scene presentation video as soon as possible, thereby improving the interaction experience of the user, and further improving the human-computer interaction rate.

FIG. 19 is a block diagram of a video generation apparatus according to another embodiment of this application. The apparatus has a function of performing the foregoing method embodiments. The function may be implemented by hardware or may be implemented by hardware executing corresponding software. The apparatus may be the terminal device introduced above, or may be disposed in the terminal device. Alternatively, the apparatus may be the server introduced above, or may be disposed in the server. As shown in FIG. 19, an apparatus 1900 may include an obtaining module 1910 and a generation module 1920.

The obtaining module 1910 is configured to obtain m framing images obtained by shooting a virtual scene, different framing images being obtained by shooting the virtual scene from different framing perspectives, and m being a positive integer.

The generation module 1920 is configured to generate, based on the m framing images, a scene presentation video corresponding to the virtual scene.

In some embodiments, the generation module 1920 includes a camera movement determining unit, a clip generation unit, and a video generation unit (which are not shown in FIG. 19).

The camera movement determining unit is configured to determine camera moving modes respectively corresponding to the m framing images, the camera moving mode being configured for indicating a moving path and a shooting angle of a virtual camera.

The clip generation unit is configured to generate, based on the camera moving modes respectively corresponding to the m framing images, scene presentation clips respectively corresponding to the m framing images, a scene presentation clip corresponding to an i^{th} framing image in the m framing images being a video clip obtained by controlling the virtual camera to shoot the virtual scene based on a moving path and a shooting angle of the virtual camera that are indicated by a camera moving mode corresponding to the i^{th} framing image, and i being a positive integer less than or equal to m.

The video generation unit is configured to generate the scene presentation video based on the scene presentation clips respectively corresponding to the m framing images.

In some embodiments, the camera movement determining unit includes a type determining sub-unit, a first camera movement sub-unit, and a second camera movement sub-unit.

The type determining sub-unit is configured to determine, for the i^{th} framing image based on a framing-point position of the i^{th} framing image, a framing-point type corresponding to the i^{th} framing image, the framing-point type being an outdoor framing point or an indoor framing point.

The first camera movement sub-unit is configured to determine, if the framing-point type of the i^{th} framing image is the outdoor framing point, that the camera moving mode corresponding to the i^{th} framing image is a first camera moving mode.

The second camera movement sub-unit is configured to determine, if the framing-point type of the i^{th} framing image is the indoor framing point, that the camera moving mode corresponding to the i^{th} framing image is a second camera moving mode.

The first camera moving mode is different from the second camera moving mode.

In some embodiments, the clip generation unit is configured to control the virtual camera to shoot the virtual scene based on a first moving path and a first shooting angle when the camera moving mode corresponding to the i^{th} framing image is the first camera moving mode, to obtain the scene presentation clip corresponding to an i^{th} framing image; the first camera moving mode including: lens zoom-in and lens rotation; the first moving path including a first sub-path that is indicated by the lens zoom-in and that is of moving from a first position to a second position along a first direction, and a second sub-path that is indicated by the lens rotation and that is of rotating from the second position to a third position in a horizontal plane around a first straight line by a first angle; and the second position being the framing-point position of the i^{th} framing image, a distance between the first position and the second position being a first distance, the first direction being a lens orientation when the i^{th} framing image is shot, and the first straight line being perpendicular to the horizontal plane; and the first shooting angle including a first shooting sub-angle that is indicated by the lens zoom-in and that is of the virtual camera during movement along the first sub-path, and a second shooting sub-angle that is indicated by the lens rotation and that is of the virtual camera during movement along the second sub-path.

In some embodiments, the clip generation unit is configured to control the virtual camera to shoot the virtual scene based on a second moving path and a second shooting angle when the camera moving mode corresponding to the i^{th} framing image is the second camera moving mode, to obtain the scene presentation clip corresponding to an i^{th} framing image; the second camera moving mode including: lens zoom-in and lens close-up; the second moving path including a third sub-path that is indicated by the lens zoom-in and that is of moving from a fourth position to a second position along a first direction, and a fourth sub-path that is indicated by the lens close-up and that is of moving from the second position to a fifth position; and the second position being the framing-point position of the i^{th} framing image, a distance between the fourth position and the second position being a second distance, the first direction being a lens orientation when the i^{th} framing image is shot, and the fifth position being a set framing-point position corresponding to a first virtual item included in the i^{th} framing image; and the second shooting angle including a third shooting sub-angle that is indicated by the lens zoom-in and that is of the virtual camera during movement along the third sub-path, and a fourth shooting sub-angle that is indicated by the lens close-up and that is of the virtual camera during movement along the fourth sub-path, the fourth shooting sub-angle being configured for controlling to adjust the lens orientation of the virtual camera from the first direction to a second direction, and the second direction being a set lens orientation corresponding to the first virtual item.

In some embodiments, the clip generation unit further includes a value scoring sub-unit and an item determining sub-unit.

The value scoring sub-unit is configured to determine a value score respectively corresponding to at least one virtual item included in the i^{th} framing image, the value score being configured for representing a shooting value of the virtual item.

The item determining sub-unit is configured to determine a virtual item with a highest value score as the first virtual item.

In some embodiments, the fourth sub-path is a path sequentially starting from the second position to a plurality of set framing-point positions based on a set shooting sequence of the plurality of set framing-point positions corresponding to the first virtual item.

In some embodiments, the type determining sub-unit is configured to obtain a construction region of a virtual building corresponding to the i^{th} framing image; and determine, if the framing-point position of the i^{th} framing image is located outside the construction region, that the framing-point type corresponding to the i^{th} framing image is the outdoor framing point; or determine, if the framing-point position of the i^{th} framing image is located within the construction region, that the framing-point type corresponding to the i^{th} framing image is the indoor framing point.

In some embodiments, the video generation unit is further configured to splice the scene presentation clips respectively corresponding to the m framing images, to generate the scene presentation video.

In conclusion, in the technical solution provided in this embodiment of this application, the plurality of framing images shot in the virtual scene are obtained, so that the scene presentation video can be directly generated based on content of the framing images, thereby implementing automatic generation of the scene presentation video, simplifying operations performed by the user, and significantly reducing production duration of the scene presentation video. Therefore, the generation efficiency of the scene presentation video is improved, so that the user can watch the scene presentation video as soon as possible, thereby improving the interaction experience of the user, and further improving the human-computer interaction rate.

When the apparatus provided in the foregoing embodiment implements the functions of the apparatus, only division of the foregoing function modules is used as an example for description. In the practical application, the functions may be allocated to and completed by different function modules according to requirements. That is, an internal structure of the device is divided into different function modules, to complete all or some of the functions described above. In addition, the apparatus provided in the foregoing embodiments and the method embodiments fall within the same conception. For details of a specific implementation process, refer to the method embodiments. Details are not described herein again.

FIG. 20 is a block diagram of a structure of a terminal device 2000 according to an embodiment of this application. The terminal device 2000 may be the terminal device 10 in the implementation environment shown in FIG. 1, and is configured to implement the video generation method provided in the foregoing embodiments. Details are as follows:

Generally, the terminal device 2000 includes a processor 2010 and a memory 2020.

The processor 2010 may include one or more processing cores, for example, a 4-core processor or an 8-core processor. The processor 2010 may be implemented in at least one hardware form of a digital signal processor (DSP for short), a field-programmable gate array (FPGA for short), and a programmable logic array (PLA for short). The processor 2010 may alternatively include a main processor and a co-processor. The main processor is a processor configured to process data in an awoken state, and is also referred to as a central processing unit (CPU for short). The co-processor is a low-power consumption processor configured to process data in a standby state. In some embodiments, the processor 2010 may be integrated with a graphics processing unit (GPU for short). The GPU is configured to render and draw content that needs to be displayed on a display screen. In some embodiments, the processor 2010 may further include an artificial intelligence (AI) processor. The AI processor is configured to process a computing operation related to machine learning.

The memory 2020 may include one or more computer-readable storage media. The computer-readable storage medium may be non-transient. In addition, the memory 2020 may further include a high-speed random access memory and a non-volatile memory, for example, one or more magnetic disk storage devices or flash memory devices. In some embodiments, the non-transient computer-readable storage medium in the memory 2020 is configured to store a computer program, and the computer program is configured to be executed by one or more processors, to implement the foregoing video generation method.

In some embodiments, the terminal device 2000 further includes a peripheral device interface 2030 and at least one peripheral device. The processor 2010, the memory 2020, and the peripheral device interface 2030 may be connected through a bus or a signal cable. Each peripheral device may be connected to the peripheral device interface 2030 through a bus, a signal cable, or a circuit board. Specifically, the peripheral device includes at least one of a radio frequency (RF) circuit 2040, a display screen 2050, an audio circuit 2060, and a power supply 2070.

A person skilled in the art may understand that the structure of shown in FIG. 20 constitutes no limitation on the terminal device 2000, and the terminal device 2000 may include more or fewer components than those shown in the figure, or some components may be combined, or in different component arrangements.

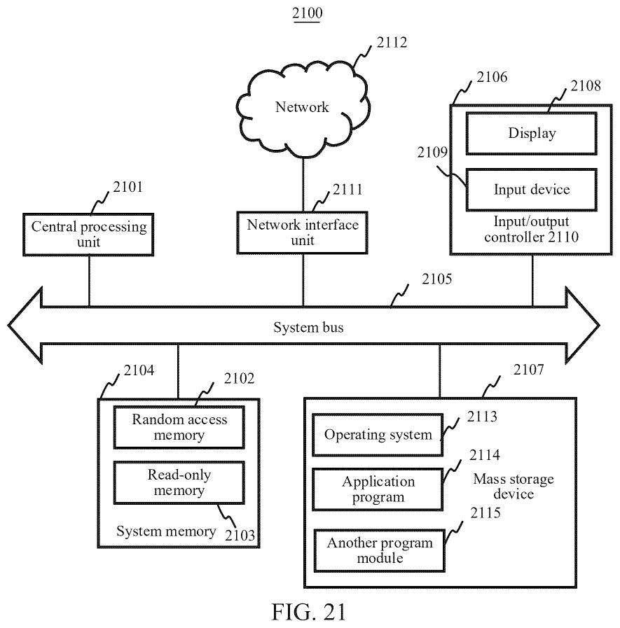

FIG. 21 is a block diagram of a structure of a server 2100 according to another embodiment of this application. The server may be configured to implement functions of the foregoing video generation method. The server 2100 may be the server 20 in the implementation environment shown in FIG. 1, and is configured to implement the video generation method provided in the foregoing embodiments. Details are as follows:

The server 2100 includes a CPU 2101, a system memory 2104 including a random access memory (RAM) 2102 and a read-only memory (ROM) 2103, and a system bus 2105 connecting the system memory 2104 to the CPU 2101. The server 2100 further includes a basic input/output (I/O) system 2106 helping transmit information between components in a computer, and a mass storage device 2107 configured to store an operating system 2113, an application program 2114, and another program module 2115.

The basic I/O system 2106 includes a display 2108 configured to display information and an input device 2109, such as a mouse or a keyboard, configured to input information by a user. The display 2108 and the input device 2109 are both connected to the CPU 2101 by using an IO controller 2110 that is connected to the system bus 2105. The basic I/O system 2106 may further include the I/O controller 2110 to be configured to receive and process inputs from multiple other devices such as a keyboard, a mouse, and an electronic stylus. Similarly, the I/O controller 2110 further provides an output to a display screen, a printer, or another type of output device.

The mass storage device 2107 is connected to the central processing unit 2101 by using a mass storage controller (not shown) that is connected to the system bus 2105. The mass storage device 2107 and a computer-readable medium associated with the mass storage device 2107 provide non-volatile storage for the server 2100. That is, the mass storage device 2107 may include a computer-readable medium (not shown) such as a hard disk or a compact disc read-only memory (CD-ROM) driver.

Generally, the computer-readable medium may include a computer storage medium and a communication medium. The computer storage medium includes volatile and non-volatile, removable and non-removable media that store information such as computer-readable instructions, data structures, program modules, or other data and that are implemented by using any method or technology. The computer storage medium includes a RAM, a ROM, an erasable programmable ROM (EPROM), an electrically erasable programmable ROM (EEPROM), a flash memory or another solid-state memory technology, a CD-ROM, a digital versatile disc (DVD) or another optical memory, a tape cartridge, a magnetic cassette, a magnetic disk memory, or another magnetic storage device. Certainly, a person skilled in the art may know that the computer storage medium is not limited to the foregoing types. The system memory 2104 and the mass storage device 2107 may be collectively referred to as memories.

According to various embodiments of this application, the server 2100 may further be connected, by using a network such as the Internet, to a remote computer on the network and run. That is, the server 2100 may be connected to a network 2112 by using a network interface unit 2111 that is connected to the system bus 2105, or may be connected to a network of another type or a remote computer system (not shown) by using the network interface unit 2111.

The memory further includes a computer program. The computer program is stored in the memory, and is configured to be executed by one or more processors, to implement the foregoing video generation method.

In an exemplary embodiment, a non-transitory computer-readable storage medium is further provided. The non-transitory computer-readable storage medium has a computer program stored therein. When the computer program is executed by a processor, a computer is enabled to implement the foregoing video generation method. In some embodiments, the non-transitory computer-readable storage medium may include a ROM, a RAM, a solid-state drive (SSD for short), an optical disc, or the like. The RAM may include a resistance random access memory (ReRAM for short) and a dynamic random access memory (DRAM for short).

In an exemplary embodiment, a computer program product is further provided, the computer program product including a computer program, and the computer program being stored in a computer-readable storage medium. A processor of a computer device reads the computer program from the computer-readable storage medium, and the processor executes the computer program, to enable the computer device to perform the foregoing video generation method.

In an exemplary embodiment, a computer program is further provided, the computer program being loaded and executed by a processor, to enable a computer to implement the foregoing video generation method.

During application of the related data collection processing in this application, informed consent or independent consent of a body of personal information needs to be obtained strictly according to requirements of laws and regulations of related nations, and subsequent data use and processing behaviors are performed within the laws and regulations and the authorization scope of the body of personal information.

“A plurality of” described in this specification refers to two or more. “And/or” describes an association relationship between associated objects and represents that three relationships may exist. For example, A and/or B may represent the following three cases: Only A exists, both A and B exist, and only B exists. The character “/” usually indicates an “or” relationship between the associated objects. In addition, the operation numbers described in this specification merely exemplarily show a possible execution sequence of the operation s. In some other embodiments, the operation s may not be performed according to the number sequence. For example, two operation s with different numbers may be performed simultaneously, or two operation s with different numbers may be performed according to a sequence contrary to the sequence shown in the figure. This is not limited in the embodiments of this application.

The foregoing descriptions are merely exemplary embodiments of this application, but are not intended to limit this application. Any modification, equivalent replacement, or improvement made within the principle of this application shall fall within the protection scope of this application. In this application, the term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit.

What is claimed is:

1. A video generation performed by a computer device, the method comprising:
displaying a picture of a virtual scene, the picture including a virtual building in the virtual scene;
in response to a framing operation for the virtual scene, shooting the virtual scene from n framing perspectives to obtain n framing images, the n framing images including a first framing image shot from a first framing perspective outside the virtual building and a second framing image shot from a second framing perspective inside the virtual building, and n being a positive integer; and
in response to an operation configured for generating a video of touring the virtual building, generating a scene presentation video based on at least the first framing image and the second framing images in the n framing images.

2. The method according to claim 1, wherein the shooting the virtual scene from n framing perspectives to obtain n framing images comprises:
displaying an image presentation bar at an upper layer of the picture of the virtual scene; and
displaying, in the image presentation bar, the n framing images shot from the n framing perspectives.

3. The method according to claim 2, wherein a video generation control is further displayed in the image presentation bar; and
the generating a scene presentation video based on at least the first framing image and the second framing images in the n framing images comprises:
generating, in response to an operation for the video generation control, the scene presentation video corresponding to the virtual scene.

4. The method according to claim 2, wherein the image presentation bar has a corresponding display or hiding control, and the display or hiding control is configured for switching a status of the image presentation bar between a displayed state and a hidden state;
and the method further comprises:
switching the status of the image presentation bar from the hidden state to the displayed state in response to an operation for the display or hiding control when the image presentation bar is in the hidden state; and
switching the status of the image presentation bar from the displayed state to the hidden state in response to an operation for the display or hiding control when the image presentation bar is in the displayed state.

5. The method according to claim 1, wherein a shooting control is further displayed at the upper layer of the picture of the virtual scene, and the framing operation is an operation for the shooting control.

6. The method according to claim 1, wherein the method further comprises:
generating, in response to an operation of adjusting the framing perspective, an image obtained by observing the virtual scene from an adjusted framing perspective.

7. The method according to claim 1, wherein the method further comprises:
in response to an operation of selecting a framing image, marking the framing image as one selected from the n framing images for generating the scene presentation video.

8. The method according to claim 1, wherein the generating a scene presentation video based on at least the first framing image and the second framing images in the n framing images comprises:
determining camera moving modes respectively corresponding to the n framing images, the camera moving mode being configured for indicating a moving path and a shooting angle of a virtual camera;
generating, based on the camera moving modes respectively corresponding to the n framing images, scene presentation clips respectively corresponding to the n framing images, a scene presentation clip corresponding to an i^{th} framing image in the n framing images being a video clip obtained by controlling the virtual camera to shoot the virtual scene based on a moving path and a shooting angle of the virtual camera that are indicated by a camera moving mode corresponding to the i^{th} framing image, and i being a positive integer less than or equal to n; and
concatenating the scene presentation clips respectively corresponding to the n framing images to obtain the scene presentation video.

9. The method according to claim 8, wherein the determining camera moving modes respectively corresponding to the n framing images comprises:
determining, for the i^{th} framing image based on a framing-point position of the i^{th} framing image, a framing-point type corresponding to the i^{th} framing image, the framing-point type being an outdoor framing point or an indoor framing point;
determining, when the framing-point type of the i^{th} framing image is the outdoor framing point, that the camera moving mode corresponding to the i^{th} framing image is a first camera moving mode; and
determining, when the framing-point type of the i^{th} framing image is the indoor framing point, that the camera moving mode corresponding to the i^{th} framing image is a second camera moving mode;
the first camera moving mode being different from the second camera moving mode.

10. The method according to claim 8, wherein the generating, based on the camera moving modes respectively corresponding to the n framing images, scene presentation clips respectively corresponding to the n framing images comprises:
controlling the virtual camera to shoot the virtual scene based on a first moving path and a first shooting angle when the camera moving mode corresponding to the i^{th} framing image is the first camera moving mode, to obtain the scene presentation clip corresponding to an i^{th} framing image;
the first camera moving mode comprising: lens zoom-in and lens rotation;
the first moving path comprising a first sub-path that is indicated by the lens zoom-in and that is of moving from a first position to a second position along a first direction, and a second sub-path that is indicated by the lens rotation and that is of rotating from the second position to a third position in a horizontal plane around a first straight line by a first angle; and the second position being the framing-point position of the i^{th} framing image, a distance between the first position and the second position being a first distance, the first direction being a lens orientation when the i^{th} framing image is shot, and the first straight line being perpendicular to the horizontal plane; and
the first shooting angle comprising a first shooting sub-angle that is indicated by the lens zoom-in and that is of the virtual camera during movement along the first sub-path, and a second shooting sub-angle that is indicated by the lens rotation and that is of the virtual camera during movement along the second sub-path.

11. The method according to claim 8, wherein the generating, based on the camera moving modes respectively corresponding to the n framing images, scene presentation clips respectively corresponding to the n framing images comprises:
controlling the virtual camera to shoot the virtual scene based on a second moving path and a second shooting angle when the camera moving mode corresponding to the i^{th} framing image is the second camera moving mode, to obtain the scene presentation clip corresponding to an i^{th} framing image;
the second camera moving mode comprising: lens zoom-in and lens close-up;
the second moving path comprising a third sub-path that is indicated by the lens zoom-in and that is of moving from a fourth position to a second position along a first direction, and a fourth sub-path that is indicated by the lens close-up and that is of moving from the second position to a fifth position; and the second position being the framing-point position of the i^{th} framing image, a distance between the fourth position and the second position being a second distance, the first direction being a lens orientation when the i^{th} framing image is shot, and the fifth position being a set framing-point position corresponding to a first virtual item comprised in the i^{th} framing image; and
the second shooting angle comprising a third shooting sub-angle that is indicated by the lens zoom-in and that is of the virtual camera during movement along the third sub-path, and a fourth shooting sub-angle that is indicated by the lens close-up and that is of the virtual camera during movement along the fourth sub-path, the fourth shooting sub-angle being configured for controlling to adjust the lens orientation of the virtual camera from the first direction to a second direction, and the second direction being a set lens orientation corresponding to the first virtual item.

12. A computer device comprising a processor and a memory, the memory having a computer program stored therein, and the computer program being loaded and executed by the processor, to enable the computer device to implement a video generation method including:
displaying a picture of a virtual scene, the picture including a virtual building in the virtual scene;
in response to a framing operation for the virtual scene, shooting the virtual scene from n framing perspectives to obtain n framing images, the n framing images including a first framing image shot from a first framing perspective outside the virtual building and a second framing image shot from a second framing perspective inside the virtual building, and n being a positive integer; and
in response to an operation configured for generating a video of touring the virtual building, generating a scene presentation video based on at least the first framing image and the second framing images in the n framing images.

13. The computer device according to claim 12, wherein the shooting the virtual scene from n framing perspectives to obtain n framing images comprises:
displaying an image presentation bar at an upper layer of the picture of the virtual scene; and
displaying, in the image presentation bar, the n framing images shot from the n framing perspectives.

14. The computer device according to claim 13, wherein a video generation control is further displayed in the image presentation bar; and
the generating a scene presentation video based on at least the first framing image and the second framing images in the n framing images comprises:
generating, in response to an operation for the video generation control, the scene presentation video corresponding to the virtual scene.

15. The computer device according to claim 13, wherein the image presentation bar has a corresponding display or hiding control, and the display or hiding control is configured for switching a status of the image presentation bar between a displayed state and a hidden state; and the method further comprises:
switching the status of the image presentation bar from the hidden state to the displayed state in response to an operation for the display or hiding control when the image presentation bar is in the hidden state; and
switching the status of the image presentation bar from the displayed state to the hidden state in response to an operation for the display or hiding control when the image presentation bar is in the displayed state.

16. The computer device according to claim 12, wherein a shooting control is further displayed at the upper layer of the picture of the virtual scene, and the framing operation is an operation for the shooting control.

17. The computer device according to claim 12, wherein the method further comprises:
generating, in response to an operation of adjusting the framing perspective, an image obtained by observing the virtual scene from an adjusted framing perspective.

18. The computer device according to claim 12, wherein the method further comprises:
in response to an operation of selecting a framing image, marking the framing image as one selected from the n framing images for generating the scene presentation video.

19. The computer device according to claim 12, wherein the generating a scene presentation video based on at least the first framing image and the second framing images in the n framing images comprises:
determining camera moving modes respectively corresponding to the n framing images, the camera moving mode being configured for indicating a moving path and a shooting angle of a virtual camera;
generating, based on the camera moving modes respectively corresponding to the n framing images, scene presentation clips respectively corresponding to the n framing images, a scene presentation clip corresponding to an i^{th} framing image in the n framing images being a video clip obtained by controlling the virtual camera to shoot the virtual scene based on a moving path and a shooting angle of the virtual camera that are indicated by a camera moving mode corresponding to the i^{th} framing image, and i being a positive integer less than or equal to n; and
concatenating the scene presentation clips respectively corresponding to the n framing images to obtain the scene presentation video.

20. A non-transitory computer-readable storage medium having a computer program stored therein, and the computer program, when being loaded and executed by a processor of a computer device, enabling the computer device to implement a video generation method including:
displaying a picture of a virtual scene, the picture including a virtual building in the virtual scene;
in response to a framing operation for the virtual scene, shooting the virtual scene from n framing perspectives to obtain n framing images, the n framing images including a first framing image shot from a first framing perspective outside the virtual building and a second framing image shot from a second framing perspective inside the virtual building, and n being a positive integer; and
in response to an operation configured for generating a video of touring the virtual building, generating a scene presentation video based on at least the first framing image and the second framing images in the n framing images.
